(19) United States
(12) Patent Application Publication
(10) Pub. No.: US 2012/0225638 A1
(43) Pub. Date: Sep. 6, 2012

(54) BROADBAND GATEWAY FEMTOCELL SERVICE ENABLING A SINGLE DEVICE TO BE USED IN A CELLPHONE MODE AND IN A CORDLESS PHONE MODE

(75) Inventor: MICHAEL SCOTT BARNES, ALPHARETTA, GA (US)

(73) Assignee: COX COMMUNICATIONS, INC., ATLANTA, GA (US)

(21) Appl. No.: 13/038,959

(22) Filed: Mar. 2, 2011

(51) Int. Cl. H04W 88/16; H04W 4/24; H04W 12/06; H04W 36/30

(52) U.S. Cl. 455/408; 455/561; 455/436; 455/411

(57) ABSTRACT

A mobile device includes a cellular transceiver for accessing a cellular network and a femtocell module for accessing a broadband network through a femtocell. The mobile device determines whether the mobile device is within range of the femtocell. The mobile device accessing the femtocell to provide telephone service using the mobile device when the mobile device is within range of the femtocell.

### FIELD OF THE INVENTION

This disclosure relates in general to, and more particularly to a broadband gateway femtocell service that enables a wireless dual mode cellphone device to also be used as the cordless phone inside the home.

### BACKGROUND

The rapid and widespread success of mobile broadband services has sparked a dramatic increase in usage, including in-home usage. Consumer demand has prompted carriers to seek alternate means of expanding in-home/in-building coverage, including the use of femtocells to provide better signal reception and to reduce traffic congestion on the wireless network.

A femtocell is a small cellular base station. The femtocell connects to the service provider's network via broadband (such as DSL or cable). By using a femtocell, service providers are able to extend service coverage indoors, especially where access would otherwise be limited or unavailable, without the need for expensive cellular towers. The use of femtocells offloads mobile traffic to fixed networks, potentially reducing both operating expenses and capital expenditures through lower required investment in network capacity. Femtocells also offer mobile service providers the opportunity to gain a greater share of the wireline market by increasing in-building service quality and accelerating the fixed to mobile transition. As a result, many operators have launched commercial femtocell services, while still others have announced plans for providing femtocell services.

Cellular companies are offering femtocells to customers, but cellular companies have a model that is based on generating as many per minute charges as possible. Thus, from a consumer standpoint, the reason for placing a wireless femtocell in the house is to compensate for ineffective coverage. However, such cellular companies still charge on a per minute basis for that usage even though the data passed through a femtocell is backhauled over the customer's own Internet traffic. Thus, the customer is paying for the use of the data pipe and also paying for per minute charges.

Although wireless carriers offer standalone femtocells for home use to bolster poor WAN coverage, no carriers are offering femtocells that combine cordless-type flat-rate service within the home and metered, mobile functionality outside the home, bundled with high-speed Internet and home phone service. Equipment manufacturers have offered dual-band phones (cordless frequencies such as 900 MHz and/or 2.4 GHz combined with cellular frequencies), but no true interoperability has been available.

In conclusion, special interfaces are required and currently no one is offering different services for the same device based on whether you are in your home or outside the home. A cordless phone typically is based on a flat rate. Cellphones may be used in the house or outside the house, but its usage is typically metered and charged by minute of airtime. Additionally, each example involves the use of a different phone.

Accordingly, it can be seen then that there is a need for providing broadband gateway femtocell service to enable a single device to be used in a cellphone or mobile mode and in a cordless phone mode with a dedicated base station.

### SUMMARY OF THE INVENTION

To overcome the limitations described above, and to overcome other limitations that will become apparent upon reading and understanding the present specification, embodiments for a broadband gateway femtocell service that enables a wireless dual mode cellphone device to also be used as the cordless phone inside the home are disclosed.

The above-described problems are solved by a Femtocell Service Network that will establish a connection between a traditional phone device and an Integrated Femtocell Broadband Gateway-connected dual mode wireless device.

In one embodiment, a mobile device is provided. The mobile device includes memory for storing data for supporting wireless communication, a processor, coupled to the memory, for processing data to support communication, a femto module, coupled to the processor, the femto module includes a femto transceiver for communicating with a femtocell providing packet-based communication over a broadband, hybrid fiber-coax or traditional POTS telephony network and a cellular transceiver, coupled to the processor, the cellular transceiver configured to provide communication with a cellular network, wherein the processor determines whether to communicate using the femto module or the cellular transceiver.

In another embodiment, a system for providing dual mode telephone service is provided. The system includes a femtocell for providing telecommunication service over a broadband, hybrid fiber-coax or traditional POTS telephony network, a cellular network, including cell towers, for supporting cellular services and a headend, coupled to the broadband network and the cellular network, for supporting the transmission of signals over the broadband network between the headend and the femtocell and over the cellular network between the headend and the cell towers.

In another embodiment, a method for providing dual mode telephone service to a mobile device is provided. The method includes providing a mobile device a cellular transceiver for accessing a cellular network, providing the mobile device a femtocell module for accessing a broadband, hybrid fiber-coax or traditional POTS telephony network through a femtocell, determining whether the mobile device is within range of the femtocell and accessing the femtocell to provide telephone service using the mobile device when the mobile device is within range of the femtocell.

In another embodiment, a computer readable medium including executable instructions which, when executed by a processor, provides dual mode telephone service to a mobile device. The service is provided by providing a mobile device a cellular transceiver for accessing a cellular network, providing the mobile device a femtocell module for accessing a broadband, hybrid fiber-coax or traditional POTS telephony network through a femtocell, determining whether the mobile device is within range of the femtocell and accessing the femtocell to provide telephone service using the mobile device when the mobile device is within range of the femtocell.

These and various other advantages and features of novelty are pointed out with particularity in the claims annexed hereto and form a part hereof. However, for a better understanding of the disclosed embodiments, the advantages, and the objects obtained, reference should be made to the drawings which form a further part hereof, and to accompanying descriptive matter, in which there are illustrated and described specific examples of the disclosed embodiments.

### BRIEF DESCRIPTION OF THE DRAWINGS

Referring now to the drawings in which like reference numbers represent corresponding parts throughout:

FIG. 1 illustrates the combining of femtocell service with digital telephony voice service allowing a wireless phone to imitate a cordless phone in the home according to one embodiment;

FIG. 2 illustrates a wireless dual mode device that can be used as the cordless phone at home or as a traditional cellphone according to one embodiment;

FIG. 3 is a simple block diagram of the Femtocell Service Network process used to establish a connection between a traditional phone device and an Integrated Femtocell Broadband Gateway-connected dual mode wireless device according to one embodiment; and

FIG. 4 illustrates a suitable computing environment for implementing a system as described above in FIGS. 1-3 according to an embodiment.

### DETAILED DESCRIPTION

Embodiments of the present invention are directed to a broadband gateway femtocell service that enables a wireless dual mode cellphone device to also be used as the cordless phone inside the home.

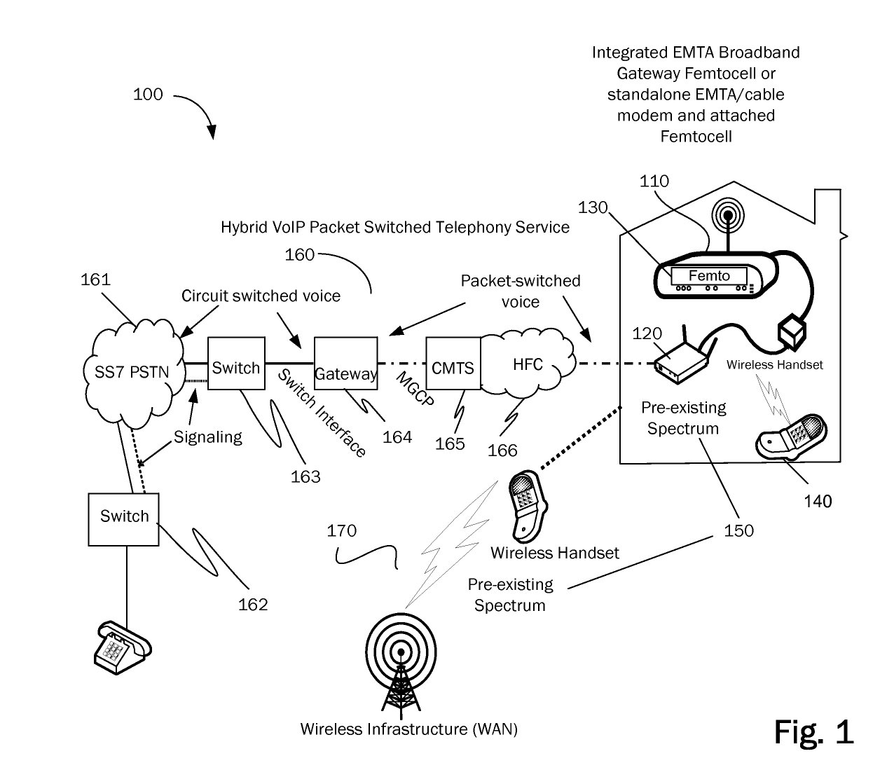

FIG. 1 illustrates the combining of femtocell service with digital telephony voice service 100 allowing a wireless phone to imitate a cordless phone in the home according to one embodiment. A broadband gateway 110 includes a DOCSIS 3.0 cable modem 120 and an 802.11n wireless router. The femtocell service incorporates a femtocell 130 into a broadband gateway 110. Customers would be able to use their wireless handset 140 in the home/WAN environment as a cordless-type phone and as a mobile phone with standard cellular handoffs outside the home. Because both types of usage rely on the same pre-existing spectrum 150, the billing and rating may be controlled and dictated by a single entity. In this situation, the femtocell 130 solution may be an extension of the digital telephony service 160 that is offered to customers. The digital telephony service 160 includes PSTN 161 provides signaling to switches 162, 163. A switch 162 may provide service to a phone. A switch 163 may also be coupled to a switch interface to access a gateway 164. The gateway 164 may be used to provide telephony services to a premise via a hybrid fiber cable (HFC) network 166. The gateway 164 is coupled to a cable modem termination system (CMTS) 165 at a headend to provide provides packet-switched voice services, such as voice over Internet Protocol telephone services, to cable subscribers. The gateway 164 is coupled to the CMTS using a media gateway control protocol. The added femtocell-based home service may thus be configured to support growth of a service provider's customer base and provide an incentive for existing customers to contract for a higher level of service.

Accordingly, a wireless phone acts like a cordless-type phone when inside the premises by using a femtocell and backhauling data over a customer's Internet service. Then, when the user is outside the premises, the wireless network 170 would allow the wireless phone to be used as a normal cell phone. Moreover, some network operators own spectrum that has not been commercialized. For example, a build operate transfer (BOT) market uses the spectrum 150 already existing within the area. Cell phone service may be provided in BOT markets once towers and infrastructure construction has been completed. In authorizing the sale of such spectrum, the FCC requires the spectrum to be used within a certain amount of time. The femtocell 130 would allow such spectrum to be used within the subscriber's home without building the wireless local or public infrastructure 170.

A combined high-speed Internet/digital telephony service/wireless offering incorporating a femtocell 130 can provide significant cost savings to the customer via bundling of these services (over the bundling discounts already planned for combinations of these services) as well as via wireless usage within the home. Depending on technical and financial feasibility, phone minutes within the home would not count against a customer's allotted wireless minutes but rather would be part of the customer's digital phone charges or an ancillary flat fee.

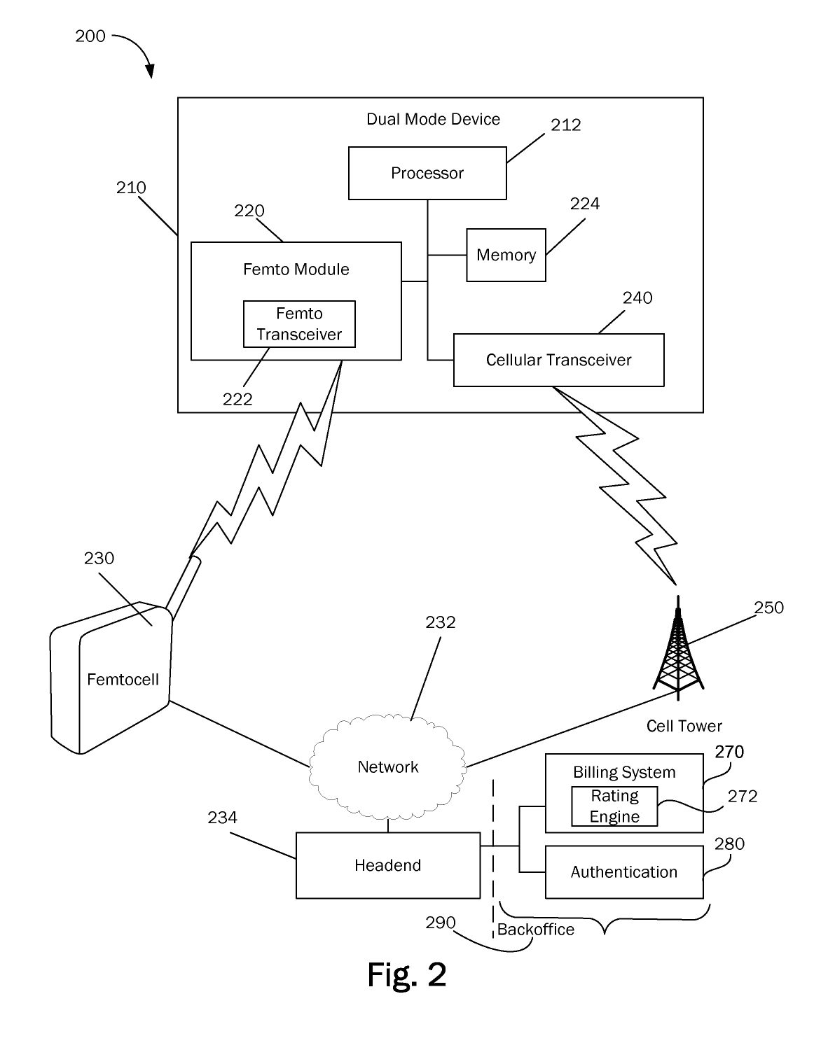

FIG. 2 illustrates a wireless dual mode device 210 that can be used as the cordless phone at home or as a traditional cellphone according to one embodiment. The dual mode device 210 supports communication using a femto module 220 or a cellular transceiver 240. Processor 212 is coupled to the femto module 220 and the cellular transceiver 240. Memory 224 is coupled to the processor and stores data for supporting wireless communication via processor 212.

The femto module 220 includes a femto transceiver 222 for communicating with a femtocell 230 that provides packet-based communication over a switched network. Cellular transceiver 240 is coupled to the processor 212 and is configured to provide communication with a cellular network. The processor determines whether to communicate using the femto module 220 or the cellular transceiver 240. The dual mode device 210 communicates with the femtocell 230 while the user is at the home to provide the digital telephony service. The femtocell 230 is coupled to a network 232. The network 232 may include a hybrid fiber coax network. The network 232 is coupled to a headend 234. The headend 234 may be coupled to a packet-switched network that accesses the PSTN through a switch as shown in FIG. 1.

The cellular transceiver 240 inside the dual mode device 210 may also communicate with cell tower 250 to provide service while outside the home. The cell tower 250 may also be coupled to the network 232. To support cellular communication, the network may also include cellular components that provide the telephone signals to the headend 234, wherein the headend routes the telephone signals to a PSTN.

Thus, the dual mode wireless device 210 would provide dual functionality of a cordless phone while inside the premises and a cellular phone when outside the premises. While operating inside the premises utilizing a femtocell 230 there would be no extra usage fees charged on top, i.e., no per minute usage fees when the wireless phone is used inside the home. When outside the home, the wireless device 210 would be coupled to the headend 234 to access the billing system 270 and authentication system 280 in the backoffice 290. The authentication system 280 would authenticate the subscriber thereby providing normal cellphone service to the subscriber. The billing system 270 and rating engine 272 monitor usage and charges applicable to cell phone usage.

To maintain integrity and session continuity of an established call or connection, a handoff between the femtocell 230 and an external cell service 250 is required. While such a handoff is not necessary, a handoff between the femtocell and the external cell service would provide a better user experience. Any handoff would also require a mapping from one call quality rating methodology to a second methodology while keeping the call intact. Furthermore, most connections will be handled entirely within the premises or entirely by the cell service, without requiring a handoff.

Referring to FIG. 1, a handoff from the external cell site 170 to the femtocell 130 would occur when a stronger signal from the femtocell 130 is available. The processor 212 monitors the signal strength to manage handoff between the femto module 220 and the cellular transceiver 240. For example, a user may be using a device outside the home. The user then arrives at home and enters the premises, where the user is within the range of the femtocell 130. The connection of the user may be maintained on the cellular network or infrastructure until the call is terminated. If the call is handed over to the femtocell 130, a transition occurs to imitate a cordless phone and the user would begin to be charged only for Internet usage (if applicable) while the cellphone usage ends and thus cellphone minute usage is minimized.

Referring again to FIG. 2, there may be a registration process associated with the femtocell so that when a call is received or transitioned, the call is routed through the Internet connection and digital telephony service. The authentication system 280 supports the authentication process. Alternatively, the phone may be configured to automatically authenticate itself with the femtocell or the external cell site based on its Mobile Identification Number (MIN). The MIN is used to uniquely identify a mobile unit within a wireless carrier's network. The backoffice 290 would be configured to identify when a handoff occurs and/or when a device switches between the femtocell and the cellphone network.

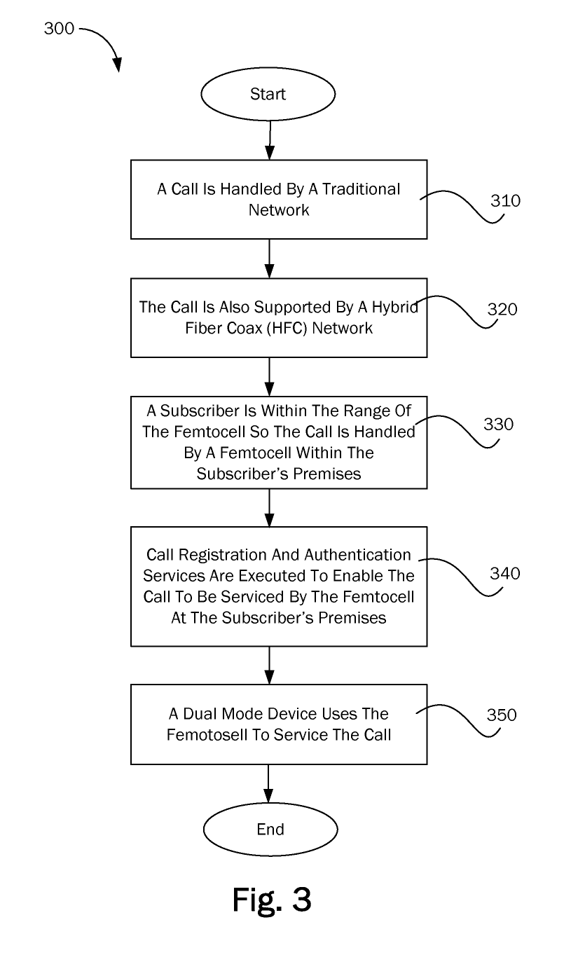

FIG. 3 is a simple block diagram 300 of the Femtocell Service Network process used to establish a connection between a traditional phone device and an Integrated Femtocell Broadband Gateway-connected dual mode wireless device according to one embodiment. A call may be handled by a traditional network 310. The call is also supported by a hybrid fiber coax (HFC) network 320. A subscriber is within the range of the femtocell so the call is handled by a femtocell within the subscriber's premises 330. Call registration and authentication services are executed to enable the call to be serviced by the femtocell at the subscriber's premises 340. A dual mode device uses the femtocell to service the call 350.

As a digital telephony customer, the customer's home phone number could be forwarded to each wireless phone, and each of these devices would ring that number. Outside the home, the customer, if subscribed to the wireless service, would be authenticated as a wireless customer and would leverage that product's operational systems and support infrastructure. Each wireless phone would have a unique MIN (Mobile Identification Number) and NPA/NXX ((Numbering Plan Area code and Central Office (exchange) code) that would also ring either inside or outside the home. The customer would receive calls from their home number as well as the unique number assigned to that device. Optimally, customers that place a call inside the home would be able to continue that call (and be picked up by a wireless cell site) when they leave the home/LAN environment, with no disruption to the call.

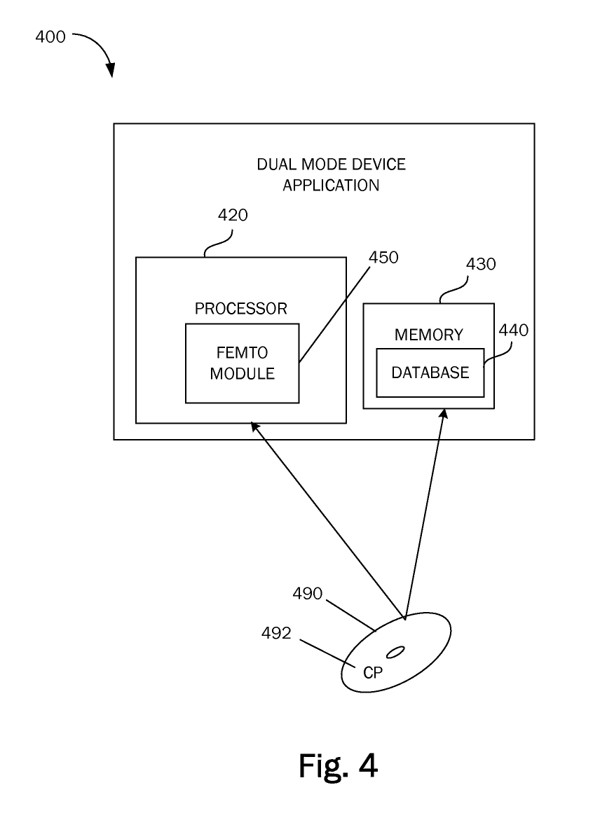

FIG. 4 illustrates a suitable computing environment 400 for implementing a system as described above in FIGS. 1-3 according to an embodiment. In FIG. 4, a dual mode device application 400 includes a processor 420 and memory 430. Those skilled in the art will recognize that a mobile dual mode device application 400 may be implemented in a head end module, a subscriber receiving device, an interactive TV, a portable media device, etc., and other data/content receiving devices. Embodiments may also be implemented in combination with other types of computer systems and program modules. Generally, program modules include routines, programs, components, data structures, and other types of structures that perform particular tasks or implement particular abstract data types. By way of example, computer readable media 490 can include computer storage media or other tangible media. Computer storage media 490 includes volatile and nonvolatile, removable and non-removable media implemented in any method or technology for storage of information 492, such as computer readable instructions, data structures, program modules or other data. Moreover, those skilled in the art will appreciate that the invention may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network.

Embodiments implemented on computer-readable media 490 may refer to a mass storage device, such as a hard disk or CD-ROM drive. However, it should be appreciated by those skilled in the art that tangible computer-readable media can be any available media that can be accessed or utilized by a processing device, e.g., server or communications network provider infrastructure.

By way of example, and not limitation, computer-readable media 490 may include, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other tangible medium which can be used to store the desired information and which can be accessed by a processing device.

As mentioned briefly above, a number of program modules and data files may be stored and arranged for controlling the operation of processing devices. Thus, one or more processing devices 420 may be configured to execute instructions that perform the operations of embodiments of the present invention.

It should also be appreciated that various embodiments of the present invention can be implemented (1) as a sequence of computer implemented acts or program modules running on a processing device and/or (2) as interconnected machine logic circuits or circuit modules within the processing devices. The implementation is a matter of choice dependent on the performance requirements. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Memory 430 thus may store the computer-executable instructions that, when executed by processor 420, cause the processor 420 to implement a femto module 450 according to an embodiment of the invention as described above with reference to FIGS. 1-3. However, memory 430 may also be configured to provide the database 440 billing as processed by processor 420.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A mobile device, comprising:
memory for storing data for supporting wireless communication;
a processor, coupled to the memory, for processing data to support communication;
a femto module, coupled to the processor, the femto module includes a femto transceiver for communicating with a femtocell providing packet-based communication over a broadband network; and
a cellular transceiver, coupled to the processor, the cellular transceiver configured to provide communication with a cellular network;
wherein the processor determines whether to communicate using the femto module or the cellular transceiver.

2. The mobile device of claim 1, wherein the femto module provides broadband telephone services without incurring per minute usage fees when within range of the femtocell.

3. The mobile device of claim 1, wherein the cellular transceiver provides cellular service outside the range of the femtocell based on a cellular charging structure.

4. The mobile device of claim 1, wherein the processor monitors signal strength to manage handoff between the femto module and the cellular transceiver.

5. A system for providing dual mode telephone service, comprising:
a femtocell for providing telecommunication service over a broadband network;
a cellular network, including cell towers, for supporting cellular services; and
a headend, coupled to the broadband network and the cellular network, for supporting the transmission of signals over the broadband network between the headend and the femtocell and over the cellular network between the headend and the cell towers.

6. The system of claim 5 further comprising:
a billing system, coupled to the headend, the billing system monitors usage by a subscriber and provides an accounting of charges for services.

7. The system of claim 6 further comprising:
a rating engine, coupled to the billing system, for providing charge information to the billing system to support accounting of charges for services.

8. The system of claim 7 further comprising:
an authentication system, coupled to the headend, for providing subscriber authentication to manage subscriber access to services through the femtocell or the cellular network.

9. The system of claim 5 further comprising:
an authentication system, coupled to the headend, for providing subscriber authentication to manage subscriber access to services through the femtocell or the cellular network.

10. The system of claim 5 a mobile device disposed within range of the femtocell or the cell towers, the mobile device establishing communication with the femtocell when in range of the femtocell to provide telephone services over a broadband network and establishing communication with the cellular network through the cell towers when the mobile device is not within range of the femtocell to provide cellular communication services.

11. The system of claim 10, wherein the mobile device includes:
memory for storing data for supporting wireless communication;
a processor, coupled to the memory, for processing data to support communication;
a femto module, coupled to the processor, the femto module includes a femto transceiver for communicating with a femtocell providing packet-based communication over a broadband network; and
a cellular transceiver, coupled to the processor, the cellular transceiver configured to provide communication with a cellular network;
wherein the processor determines whether to communicate using the femto module or the cellular transceiver.

12. The system of claim 11, wherein the femto module provides broadband telephone services without incurring per minute usage fees when within range of the femtocell.

13. The system of claim 11, wherein the cellular transceiver provides cellular service outside the range of the femtocell based on a cellular charging structure.

14. The system of claim 11, wherein the processor monitors signal strength to manage handoff between the femto module and the cellular transceiver.

15. A method for providing dual mode telephone service to a mobile device, comprising:
providing a mobile device a cellular transceiver for accessing a cellular network;
providing the mobile device a femtocell module for accessing a broadband network through a femtocell;
determining whether the mobile device is within range of the femtocell; and
accessing the femtocell to provide telephone service using the mobile device when the mobile device is within range of the femtocell.

16. The method of claim 15 further comprising accessing the cellular network through the cell towers to provide telephone service using the mobile device when the mobile device is not within range of the femtocell.

17. The method of claim 15 further comprising executing call registration and authentication services to enable the call to be serviced by the femtocell.

18. A computer readable medium including executable instructions which, when executed by a processor, provides dual mode telephone service to a mobile device, by:
providing a mobile device a cellular transceiver for accessing a cellular network;
providing the mobile device a femtocell module for accessing a broadband network through a femtocell;
determining whether the mobile device is within range of the femtocell; and
accessing the femtocell to provide telephone service using the mobile device when the mobile device is within range of the femtocell.

19. The method of claim 18 further comprising accessing the cellular network through the cell towers to provide telephone service using the mobile device when the mobile device is not within range of the femtocell.

20. The method of claim 18 further comprising executing call registration and authentication services to enable the call to be serviced by the femtocell.
